(19) United States
(12) Patent Application Publication
(10) Pub. No.: US 2017/0301935 A1
(43) Pub. Date: Oct. 19, 2017

(54) APPARATUS AND METHOD FOR CONTROLLING FUEL CELL STACK

(71) Applicant: HYUNDAI MOTOR COMPANY, Seoul (KR)

(72) Inventor: Yei Sik JEON, Seoul (KR)

(21) Appl. No.: 15/224,270

(22) Filed: Jul. 29, 2016

(30) Foreign Application Priority Data
Apr. 19, 2016 (KR) 10-2016-0047685

(51) Int. Cl. H01M 8/04828; H01M 8/0438; H01M 8/04992; H01M 8/0432; H01M 8/04701; H01M 8/04746; H01M 8/04537; H01M 8/1018

(52) U.S. Cl. CPC H01M 8/04828; H01M 8/04746; H01M 8/0438; H01M 8/04589; H01M 8/04992; H01M 8/04358; H01M 8/04723; H01M 2008/1095; H01M 2250/20; H01M 2300/0082

(57) ABSTRACT

An apparatus for controlling a fuel cell stack includes: a map storage storing a target relative humidity map in which a target relative humidity corresponding to a vapor pressure of the fuel cell stack and a coolant temperature of the fuel cell stack is recorded; a pressure sensor measuring an outlet pressure of the fuel cell stack; a current sensor measuring a current generated by the fuel cell stack; a water temperature sensor measuring a coolant temperature of the fuel cell stack; and a fuel cell controller configured to determine a state of the fuel cell stack using a relative humidity of the fuel cell stack based on the target relative humidity map, and to set an amount of airflow or a coolant temperature according to the state of the fuel cell stack.

### CROSS-REFERENCE TO RELATED APPLICATION

This application is based on and claims the benefit of priority to Korean Patent Application No. 10-2016-0047685, filed on Apr. 19, 2016, in the Korean Intellectual Property Office, the disclosure of which is incorporated herein in its entirety by reference.

### TECHNICAL FIELD

The present disclosure relates to an apparatus and a method for controlling a fuel cell stack, and more particularly, to a technology for optimizing the operating efficiency of a fuel cell stack by determining the state, such as dry or flooding, of the fuel cell stack on the basis of a map in which a target relative humidity corresponding to a vapor pressure of the fuel cell stack and a coolant temperature thereof is recorded and controlling the amount of airflow and a coolant temperature according to the determined state of the fuel cell stack.

### BACKGROUND

A fuel cell is a device that can produce electricity by converting chemical energy from a fuel into electrical energy through an electrochemical reaction within a fuel cell stack, instead of converting the chemical energy from the fuel into heat through combustion. Fuel cells may not only provide power for industries, households, and vehicles, but may also be applied to power supply for small electric/electronic products, especially, portable devices.

Currently, proton exchange membrane fuel cells (PEMFCs), also known as polymer electrolyte membrane fuel cells, having the highest power density among fuel cells are extensively being studied as a power source for driving vehicles. The PEMFCs have a quick startup time and a quick power conversion response time due to a low operating temperature.

Such a PEMFC includes: a membrane electrode assembly (MEA) having catalyst electrode layers, in which an electrochemical reaction occurs, attached to both sides of a solid polymer electrolyte membrane through which hydrogen ions move; gas diffusion layers (GDLs) serving to uniformly distribute reactant gases and deliver electrical energy that is generated; gaskets and coupling members for maintaining air tightness of the reactant gases and a coolant and appropriate clamping pressure; and bipolar plates allowing the reactant gases and the coolant to move therethrough.

When such unit cells are assembled to foci a fuel cell stack, a combination of main components, MEA and GDL, is positioned in the innermost portion of the cell. The MEA includes the catalyst electrode layers, i.e., an anode and a cathode with a catalyst coated on both surfaces of the polymer electrolyte membrane so as to allow hydrogen and oxygen to react with each other. The GDLs, the gaskets, and the like are stacked on the anode and the cathode in an outer portion of the cell.

The bipolar plates having respective flow fields formed therein are positioned outwardly of the GDLs, the flow fields supplying the reactant gases (hydrogen as a fuel and oxygen or air as an oxidizing agent) and allowing the coolant to pass therethrough.

After the plurality of unit cells having the above-described configuration are stacked, current collectors, insulating plates, and end plates for supporting the stacked cells are combined in the outermost portion of the stack. The unit cells are repeatedly stacked and assembled between the end plates to form the fuel cell stack.

In order to obtain an electric potential required in a vehicle, it is necessary to stack the number of unit cells corresponding to the required amount of electric potential energy, and the stacked unit cells are called a stack. For example, an electric potential generated from a single unit cell is about 1.3V, and in order to generate power required for driving a vehicle, the plurality of cells may be stacked in series.

Such a fuel cell stack may not provide optimal operating efficiency in a dry or flooding state.

Conventionally, when an outlet humidity of a fuel cell stack that is estimated on the basis of a humidity estimation model of the stack is maintained to be lower than or equal to a reference value for a predetermined period of time, a radiator fan and a cooling pump are forcibly driven to reduce a coolant temperature of the stack. When the outlet humidity is increased and is maintained to exceed the reference value for a predetermined time, the driving of the radiator fan and the cooling pump stops.

According to the related art, when the outlet humidity of the stack is maintained to be lower than or equal to the reference value for a predetermined time or to exceed the reference value for a predetermined time, the coolant temperature of the stack is adjusted. Thus, a coolant temperature difference (an operating temperature difference) is increased, which causes the degradation of durability due to thermal shock.

In addition, in order to cover the large coolant temperature difference, an operating time of the radiator fan and the cooling pump is increased, which causes an increase in electricity consumption.

### SUMMARY

The present disclosure has been made to solve the above-mentioned problems occurring in the prior art while advantages achieved by the prior art are maintained intact.

An aspect of the present disclosure provides an apparatus and a method for controlling a fuel cell stack that can optimize the operating efficiency of a fuel cell stack by determining the (dry or flooding) state of the fuel cell stack on the basis of a map in which a target relative humidity corresponding to a vapor pressure of the fuel cell stack and a coolant temperature thereof is recorded and controlling an amount of airflow and a coolant temperature according to the determined state of the fuel cell stack.

The object of the present disclosure is not limited to the foregoing object, and any other objects and advantages not mentioned herein will be clearly understood from the following description. The present inventive concept will be more clearly understood from exemplary embodiments of the present disclosure. In addition, it will be apparent that the objects and advantages of the present disclosure can be achieved by the elements claimed in the claims and a combination thereof.

According to an embodiment in the present disclosure, an apparatus for controlling a fuel cell stack includes: a map storage storing a target relative humidity map in which a target relative humidity corresponding to a vapor pressure of the fuel cell stack and a coolant temperature of the fuel cell stack is recorded; a pressure sensor measuring an outlet pressure of the fuel cell stack; a current sensor measuring a current generated by the fuel cell stack; a water temperature sensor measuring a coolant temperature of the fuel cell stack; and a fuel cell controller determining a state of the fuel cell stack using a relative humidity of the fuel cell stack on the basis of the target relative humidity map, and setting an amount of airflow or a coolant temperature according to the state of the fuel cell stack.

The map storage may include a maximum relative humidity map and a minimum relative humidity map generated on the basis of the target relative humidity map.

The fuel cell controller may reduce the amount of airflow to increase the relative humidity of the fuel cell stack when the relative humidity of the fuel cell stack is between the target relative humidity map and the minimum relative humidity map.

The fuel cell controller may reduce the coolant temperature to increase the relative humidity of the fuel cell stack when the relative humidity of the fuel cell stack corresponds to a minimum relative humidity. The fuel cell controller may set the coolant temperature to be lower than the coolant temperature of the target relative humidity map by a threshold value

The fuel cell controller may increase the amount of airflow to reduce the relative humidity of the fuel cell stack when the relative humidity of the fuel cell stack is between the target relative humidity map and the maximum relative humidity map.

The fuel cell controller may increase the coolant temperature to reduce the relative humidity of the fuel cell stack when the relative humidity of the fuel cell stack corresponds to a maximum relative humidity. The fuel cell controller may set the coolant temperature to be higher than the coolant temperature of the target relative humidity map by a threshold value.

According to another embodiment in the present disclosure, a method for controlling a fuel cell stack includes: storing a target relative humidity map in which a target relative humidity corresponding to a vapor pressure of the fuel cell stack and a coolant temperature of the fuel cell stack is recorded; calculating a relative humidity of the fuel cell stack using a vapor pressure of air discharged from the fuel cell stack and a saturated vapor pressure at a coolant temperature; determining a state of the fuel cell stack using the calculated relative humidity of the fuel cell stack on the basis of the target relative humidity map; and setting an amount of airflow or a coolant temperature of the fuel cell stack according to the state of the fuel cell stack.

### BRIEF DESCRIPTION OF THE DRAWINGS

The above and other objects, features and advantages of the present disclosure will be more apparent from the following detailed description taken in conjunction with the accompanying drawings.

FIG. 1 illustrates the configuration of an apparatus for controlling a fuel cell stack, according to an exemplary embodiment in the present disclosure.

FIG. 2 illustrates a target relative humidity map of a fuel cell stack, according to an exemplary embodiment in the present disclosure.

FIG. 3 illustrates a process of controlling a relative humidity of a fuel cell stack in a dry state, according to an exemplary embodiment in the present disclosure.

FIG. 4 illustrates a process of controlling a relative humidity of a fuel cell stack in a flooding state, according to an exemplary embodiment in the present disclosure.

FIG. 5 illustrates a flowchart of a method for controlling a fuel cell stack, according to an exemplary embodiment in the present disclosure.

### DETAILED DESCRIPTION

The above and other objects, features and advantages of the present disclosure will be more clearly understood from the following detailed description taken in conjunction with the accompanying drawings so that those skilled in the art to which the present disclosure pertains can easily carry out technical ideas described herein. In addition, a detailed description of well-known techniques associated with the present disclosure will be ruled out in order not to unnecessarily obscure the gist of the present disclosure. Hereinafter, exemplary embodiments in the present disclosure will be described in detail with reference to the accompanying drawings.

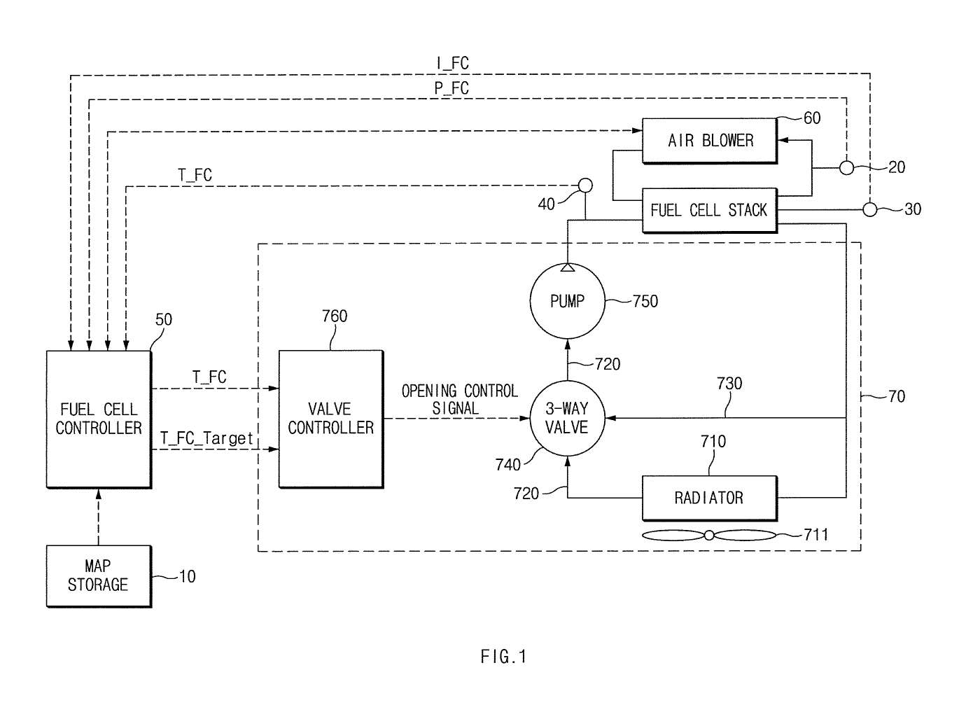

FIG. 1 illustrates the configuration of an apparatus for controlling a fuel cell stack, according to an exemplary embodiment in the present disclosure.

As illustrated in FIG. 1, the apparatus for controlling a fuel cell stack, according to the present disclosure, includes a map storage 10, a pressure sensor 20, a current sensor 30, a water temperature sensor 40, a fuel cell controller 50, an air blower 60, and a temperature controller 70.

With respect to each of the aforementioned elements, first, the map storage 10 may store a map in which a target relative humidity corresponding to a vapor pressure of the fuel cell stack and a coolant temperature thereof is recorded.

In other words, the map storage 10 may store a map (hereinafter referred to as a “target relative humidity map”) in which the target relative humidity corresponding to the vapor pressure of air discharged from the fuel cell stack and the coolant temperature (operating temperature) of the fuel cell stack is recorded.

In this embodiment of the present disclosure, the map storage 10 may be provided as a separate module; however, in some embodiments, the fuel cell controller 50 may be configured to include the map storage 10.

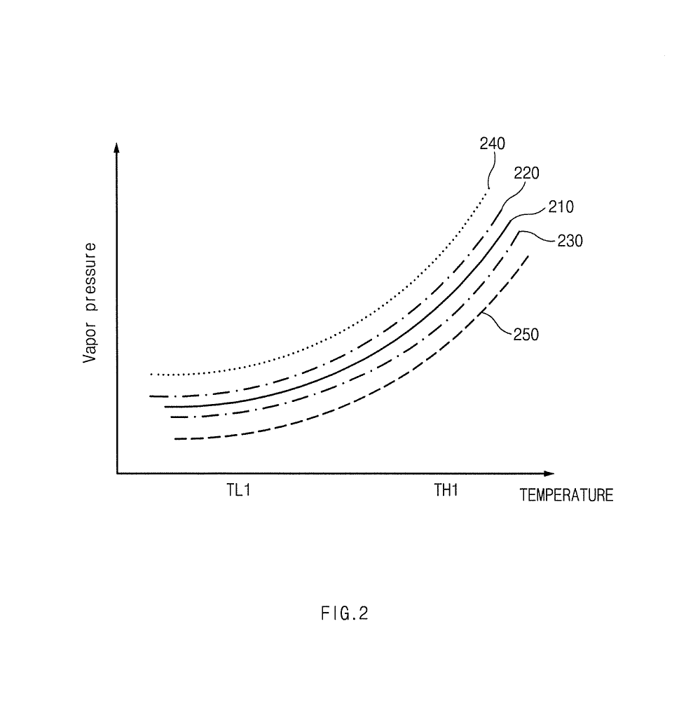

Hereinafter, a target relative humidity map 201 will be detailed with reference to FIG. 2.

In FIG. 2, an X-axis indicates a coolant temperature, and a Y-axis indicates a vapor pressure of air.

Furthermore, numeral reference “210” denotes a target relative humidity map corresponding to the vapor pressure of the fuel cell stack and the coolant temperature of the fuel cell stack.

Numeral reference “220” denotes a map (hereinafter referred to as a “high target relative humidity map”) generated on the basis of the target relative humidity map 210, which is set to be greater than the target relative humidity map 210 by a constant value so as to reduce the coolant temperature quickly when it is determined that the fuel cell stack is in a dry state. That is, the high target relative humidity map 220 is greater than the target relative humidity map 210 by a constant value at the same vapor pressure and the same coolant temperature.

Numeral reference “230” denotes a map (hereinafter referred to as a “low target relative humidity map) generated on the basis of the target relative humidity map 210, which is set to be less than the target relative humidity map 210 by a constant value so as to increase the coolant temperature quickly when it is determined that the fuel cell stack is in a flooding state. That is, the low target relative humidity map 230 is less than the target relative humidity map 210 by a constant value at the same vapor pressure and the same coolant temperature.

The high target relative humidity map 220 and the low target relative humidity map 230 may be advantageously used for quickly controlling the fuel cell stack. However, the fuel cell stack may also be controlled on the basis of the target relative humidity map 210.

Numeral reference “240” denotes a map (hereinafter referred to as a “maximum relative humidity map”) indicating a maximum value of relative humidity corresponding to a vapor pressure of air discharged from the fuel cell stack and a coolant temperature of the fuel cell stack, which is used as a factor for determining the timing of controlling (increasing) the coolant temperature. In other words, when the relative humidity of the fuel cell stack exceeds the maximum relative humidity, the fuel cell controller 50 may determine that controlling an amount of airflow to be supplied to the fuel cell stack is not enough to normalize the relative humidity of the fuel cell stack, and may start to control the coolant temperature (to increase the coolant temperature).

Numeral reference “250” denotes a map (hereinafter referred to as a “minimum relative humidity map”) indicating a minimum value of relative humidity corresponding to a vapor pressure of air discharged from the fuel cell stack and a coolant temperature of the fuel cell stack, which is used as a factor for determining the timing of controlling (reducing) the coolant temperature. In other words, when the relative humidity of the fuel cell stack is lower than the minimum relative humidity, the fuel cell controller 50 may determine that controlling an amount of airflow to be supplied to the fuel cell stack is not enough to normalize the relative humidity of the fuel cell stack, and may start to control the coolant temperature (to reduce the coolant temperature).

The pressure sensor 20 may be positioned in a channel of supply of air discharged from the fuel cell stack to measure an outlet pressure of the fuel cell stack. In other words, the pressure sensor 20 may measure the pressure of the air discharged from the fuel cell stack.

The current sensor 30 may measure a current generated by the fuel cell stack.

The water temperature sensor 40 may measure the coolant temperature of the fuel cell stack. In this embodiment of the present disclosure, the water temperature sensor 40 may be configured to measure a temperature of a coolant supplied to the fuel cell stack by way of example; however, in some embodiments, the water temperature sensor 40 may be configured to measure a temperature of a coolant discharged from the fuel cell stack, or in other embodiment, the water temperature sensor 40 may be configured to measure an average temperature of a temperature of a coolant supplied to the fuel cell stack and a temperature of a coolant discharged from the fuel cell stack.

The fuel cell controller 50 generally controls the aforementioned respective elements to perform the functions thereof normally.

In particular, the fuel cell controller 50 may calculate the relative humidity of the fuel cell stack, determine the state of the fuel cell stack on the basis of the target relative humidity map stored in the map storage 10, and control the amount of airflow or the temperature of the coolant to be supplied to the fuel cell stack according to the state of the fuel cell stack. In other words, the fuel cell controller 50 may set the amount of airflow or the temperature of the coolant to be supplied to the fuel cell stack according to the state of the fuel cell stack.

Specifically, when it is determined that the fuel cell stack is in a dry state, i.e., when the relative humidity of the fuel cell stack is between the target relative humidity map 210 and the minimum relative humidity map 250, the fuel cell controller 50 controls the air blower 60 to primarily adjust the amount of airflow to thereby control the relative humidity of the fuel cell stack. When the relative humidity of the fuel cell stack corresponds to the minimum relative humidity despite the airflow control, the fuel cell controller 50 controls the temperature controller 70 to secondarily adjust the coolant temperature of the fuel cell stack.

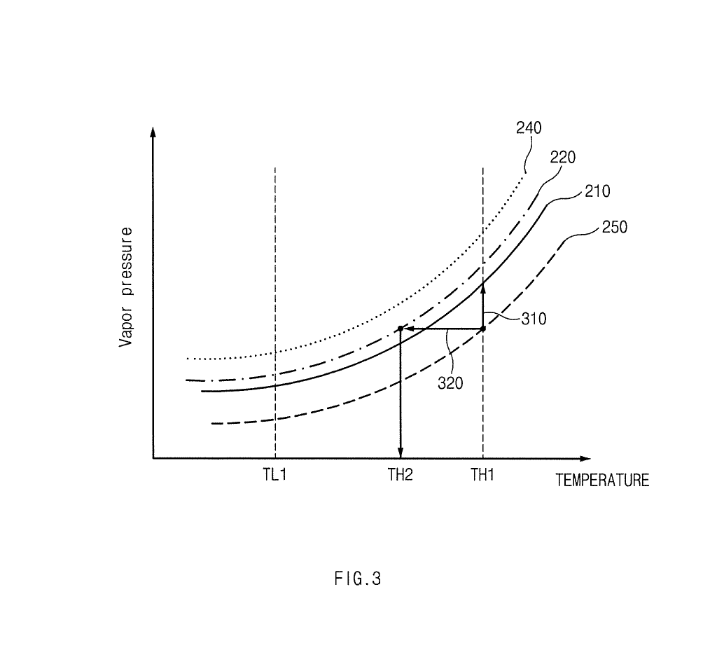

Hereinafter, a process of controlling, by the fuel cell controller 50, a relative humidity of a fuel cell stack in a dry state will be detailed with reference to FIG. 3.

In FIG. 3, numeral reference “310” denotes a variation region of relative humidity according to airflow, and the relative humidity of the fuel cell stack may be controlled to be increased in the variation region 310 by reducing the amount of airflow supplied to the fuel cell stack. Although the amount of airflow is reduced to a minimum amount required for the fuel cell stack to operate normally, when the relative humidity of the fuel cell stack corresponds to the minimum relative humidity, the fuel cell controller 50 reduces the coolant temperature (TH1->TH2) to control the relative humidity of the fuel cell stack to correspond to a target relative humidity. That is, the fuel cell controller 50 may perform a secondary coolant temperature control 320.

Here, in order to quickly increase the relative humidity of the fuel cell stack to the target relative humidity, the high target relative humidity map 220 may be used. For example, if a coolant temperature required for normalizing the fuel cell stack in a dry state is 10° C. on the basis of the target relative humidity map 210, a coolant temperature required for normalizing the fuel cell stack in a dry state is 7-8° C. on the basis of the high target relative humidity map 220.

In addition, when it is determined that the fuel cell stack is in a flooding state, i.e., when the relative humidity of the fuel cell stack is between the target relative humidity map 210 and the maximum relative humidity map 240, the fuel cell controller 50 controls the air blower 60 to primarily adjust the amount of airflow to thereby control the relative humidity of the fuel cell stack. When the relative humidity of the fuel cell stack corresponds to the maximum relative humidity despite the airflow control, the fuel cell controller 50 controls the temperature controller 70 to secondarily adjust the coolant temperature of the fuel cell stack.

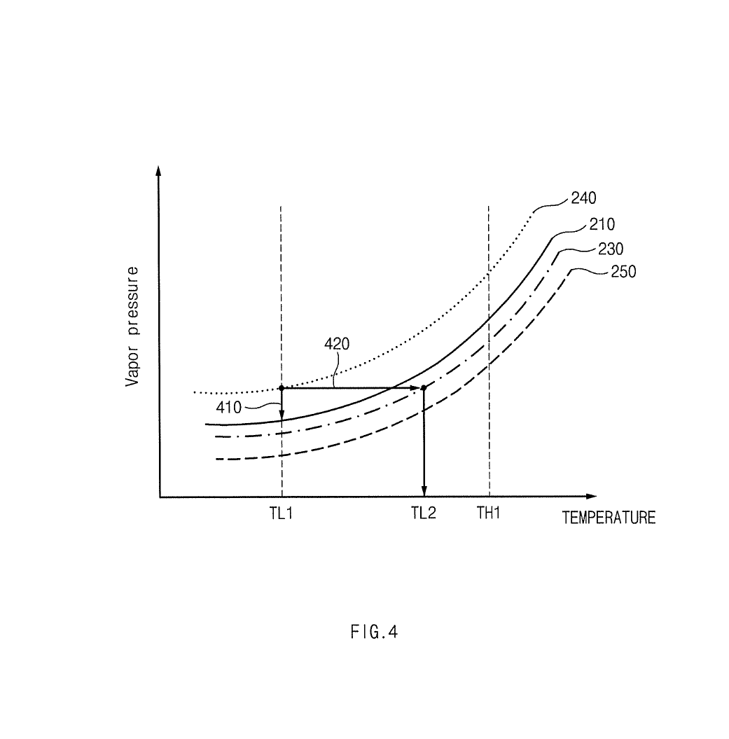

Hereinafter, a process of controlling, by the fuel cell controller 50, a relative humidity of a fuel cell stack in a flooding state will be detailed with reference to FIG. 4.

In FIG. 4, numeral reference “410” denotes a variation region of relative humidity according to airflow, and the relative humidity of the fuel cell stack may be controlled to be reduced in the variation region 410 by increasing the amount of airflow supplied to the fuel cell stack. Although the amount of airflow is increased to a maximum amount, when the relative humidity of the fuel cell stack corresponds to the maximum relative humidity, the fuel cell controller 50 increases the coolant temperature (TH1->TH2) to control the relative humidity of the fuel cell stack to correspond to a target relative humidity. That is, the fuel cell controller 50 may perform a secondary coolant temperature control 420.

Here, in order to quickly reduce the relative humidity of the fuel cell stack to the target relative humidity, the low target relative humidity map 230 may be used. For example, if a coolant temperature required for normalizing the fuel cell stack in a flooding state is 30° C. on the basis of the target relative humidity map 210, a coolant temperature required for normalizing the fuel cell stack in a flooding state is 32-33° C. on the basis of the low target relative humidity map 230.

A process of calculating, by the fuel cell controller 50, a relative humidity (RH) of a fuel cell stack will be detailed below.

The fuel cell controller 50 may calculate a relative humidity (RH) on the basis of equation 1 below. Here, the fuel cell controller 50 includes a table in which amounts of moisture corresponding to current values are recorded, and a table in which amounts of discharge of water corresponding to amounts of moisture are recorded.

$$RH = \frac{{P}_{v}}{{P}_{sat} ( T\_FC )} \qquad [ Equation 1 ]$$

Here, T_FC indicates a coolant temperature; Pₛₐₜ(T_FC) indicates a saturated vapor pressure at a coolant temperature; and Pv indicates a vapor pressure of air discharged from the fuel cell stack. Pv may be calculated through the following equation 2:

$$Pv = \frac{\frac{Mv}{Mair} \times }{0.622 + \frac{Mv}{Mair}} \qquad [ Equation 2 ]$$

Here, Mair indicates an amount of airflow supplied to the fuel cell stack, and P indicates a pressure measured by the pressure sensor 20. My indicates Ms−Ma, where Ms indicates an amount of moisture generated in proportion to a current value measured by the current sensor 30, and Ma indicates an amount of discharge of water corresponding to the amount of moisture.

According to another exemplary embodiment, when a humidifier is provided between the fuel cell stack and the air blower, the relative humidity of the fuel cell stack may be calculated using Mv=Ms+Mh−Ma. Here, Mh indicates an amount of moisture supplied to the fuel cell stack by the humidifier.

The air blower 60 may control the amount of airflow to be supplied to the fuel cell stack under control of the fuel cell controller 50.

The temperature controller 70 may control the coolant temperature under control of the fuel cell controller 50.

That is, the temperature controller 70 may receive a current coolant temperature (T_FC) and a target coolant temperature (T_FC_Target) from the fuel cell controller 50, and control the coolant temperature.

For example, the temperature controller 70 includes a radiator 710 and a cooling fan 711 for dissipating heat of a coolant externally, a coolant line 720 connected between the fuel cell stack and the radiator 710 to allow the coolant to circulate, a bypass line 730 bypassing the radiator 710 in order to prevent the coolant from passing through the radiator 710, a 3-way valve 740 adjusting an amount of the coolant passing through the radiator 710 and the bypass line 730, a pump 750 pumping the coolant from the coolant line 720, and a valve controller 760.

The 3-way valve 740 may be an electronic valve of which the opening is controlled according to an electrical signal (a control signal) from an external controller. Here, the electronic valve may be an electronic thermostat using a wax pellet or an electronic 3-way valve which is driven by a solenoid or a motor and of which the opening is controlled.

The opening control of the 3-way valve 740 may depend on the control signal output from the valve controller 760. The valve controller 760 may receive a stack inlet coolant temperature target value (T_FC_Target) and a stack inlet coolant temperature (T_FC) from the fuel cell controller 50, and control the opening of the 3-way valve 740 on the basis of the received values so as to allow the stack inlet coolant temperature to meet the target value.

When the opening of the 3-way valve 740 is controlled through the angular rotation of a valve body by the motor, the valve controller 760 may apply a motor control signal for controlling a rotation angle (an opening angle) of the valve body to the 3-way valve 740.

When the amount of the coolant passing through the radiator 710 and the bypass line 730 is controlled by the 3-way valve 740, the temperature of the coolant supplied to the fuel cell stack, i.e., the stack inlet coolant temperature may be controlled, and thus, the operating temperature of the fuel cell stack may be controlled.

In this embodiment of the present disclosure, the fuel cell controller 50 and the valve controller 760 are provided as separate modules by way of example; however, the fuel cell controller 50 and the valve controller 760 may be provided as a single integrated controller calculating the stack inlet coolant temperature target value (T_FC_Target) and directly controlling the 3-way valve 740.

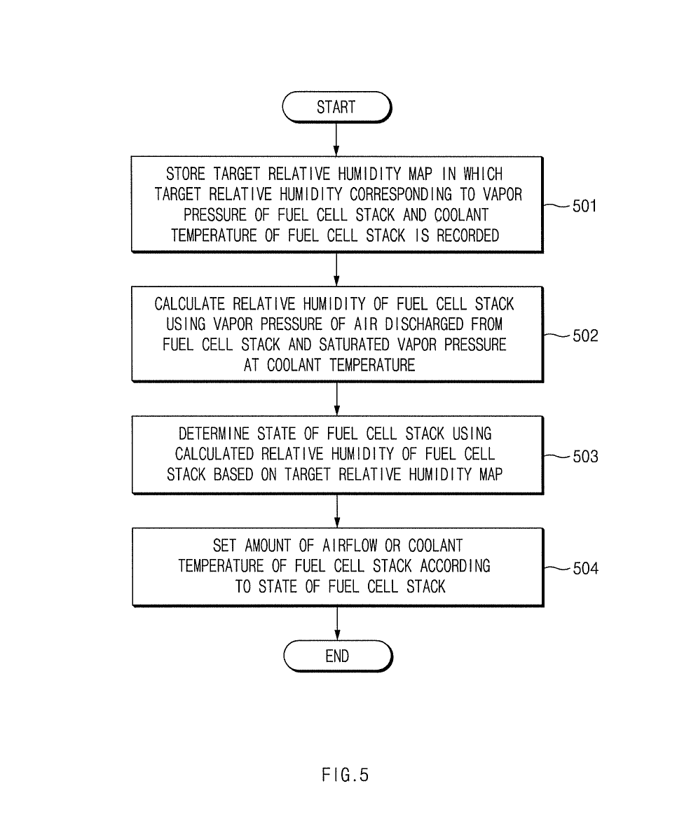

FIG. 5 illustrates a flowchart of a method for controlling a fuel cell stack, according to an exemplary embodiment in the present disclosure.

First, the map storage 10 may store a target relative humidity map in which a target relative humidity corresponding to a vapor pressure of the fuel cell stack and a coolant temperature of the fuel cell stack is recorded, in operation 501.

Next, the fuel cell controller 50 may calculate a relative humidity of the fuel cell stack using a vapor pressure of air discharged from the fuel cell stack and a saturated vapor pressure at a coolant temperature, in operation 502.

Thereafter, the fuel cell controller 50 may determine a state of the fuel cell stack using the calculated relative humidity of the fuel cell stack on the basis of the target relative humidity map, in operation 503.

Then, the fuel cell controller 50 may set an amount of airflow or a coolant temperature of the fuel cell stack according to the state of the fuel cell stack, in operation 504.

The above-stated method according to the exemplary embodiment in the present disclosure may be written as a computer program. Codes and code segments constituting the program may easily be inferred by a computer programmer skilled in the art. In addition, the written program may be stored in a non-transitory computer-readable recording medium (an information storage medium) and be read and executed by a computer, thereby implementing the method according to the exemplary embodiment in the present disclosure. The recording medium includes all types of computer-readable recording media.

As set forth above, the operating efficiency of a fuel cell stack may be optimized by determining the (dry or flooding) state of the fuel cell stack on the basis of a map in which a target relative humidity corresponding to a vapor pressure of the fuel cell stack and a coolant temperature thereof is recorded, and controlling an amount of airflow and the coolant temperature according to the determined state of the fuel cell stack.

In addition, by applying the present inventive concept to a fuel cell vehicle, fuel-efficiency of the fuel cell vehicle may be improved.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for controlling a fuel cell stack, the apparatus comprising:
a map storage storing a target relative humidity map in which a target relative humidity corresponding to a vapor pressure of the fuel cell stack and a coolant temperature of the fuel cell stack is recorded;
a pressure sensor measuring an outlet pressure of the fuel cell stack;
a current sensor measuring a current generated by the fuel cell stack;
a water temperature sensor measuring a coolant temperature of the fuel cell stack; and
a fuel cell controller configured to determine a state of the fuel cell stack using a relative humidity of the fuel cell stack based on the target relative humidity map, and to set an amount of airflow or a coolant temperature according to the state of the fuel cell stack.

2. The apparatus according to claim 1, wherein the map storage includes a maximum relative humidity map and a minimum relative humidity map generated based on the target relative humidity map.

3. The apparatus according to claim 2, wherein the fuel cell controller reduces the amount of airflow to increase the relative humidity of the fuel cell stack when the relative humidity of the fuel cell stack is between the target relative humidity map and the minimum relative humidity map.

4. The apparatus according to claim 3, wherein the fuel cell controller reduces the coolant temperature to increase the relative humidity of the fuel cell stack when the relative humidity of the fuel cell stack corresponds to a minimum relative humidity.

5. The apparatus according to claim 4, wherein the fuel cell controller sets the coolant temperature to be lower than the coolant temperature of the target relative humidity map by a threshold value.

6. The apparatus according to claim 2, wherein the fuel cell controller increases the amount of airflow to reduce the relative humidity of the fuel cell stack when the relative humidity of the fuel cell stack is between the target relative humidity map and the maximum relative humidity map.

7. The apparatus according to claim 6, wherein the fuel cell controller increases the coolant temperature to reduce the relative humidity of the fuel cell stack when the relative humidity of the fuel cell stack corresponds to a maximum relative humidity.

8. The apparatus according to claim 7, wherein the fuel cell controller sets the coolant temperature to be higher than the coolant temperature of the target relative humidity map by a threshold value.

9. The apparatus according to claim 1, wherein the fuel cell controller calculates the relative humidity of the fuel cell stack using a vapor pressure of air discharged from the fuel cell stack and a saturated vapor pressure at a coolant temperature.

10. The apparatus according to claim 9, wherein the fuel cell controller calculates the vapor pressure of the air using an amount of airflow supplied to the fuel cell stack, a pressure measured by the pressure sensor, an amount of moisture generated in proportion to a current value measured by the current sensor, and an amount of discharge of water corresponding to the amount of moisture.

11. The apparatus according to claim 10, wherein the fuel cell controller calculates the vapor pressure of the air by further using an amount of moisture supplied to the fuel cell stack by a humidifier.

12. The apparatus according to claim 1, wherein the water temperature sensor calculates a temperature of a coolant discharged from the fuel cell stack.

13. The apparatus according to claim 1, wherein the water temperature sensor calculates a temperature of a coolant supplied to the fuel cell stack.

14. The apparatus according to claim 1, wherein the water temperature sensor calculates an average temperature of a temperature of a coolant supplied to the fuel cell stack and a temperature of a coolant discharged from the fuel cell stack.

15. A method for controlling a fuel cell stack, the method comprising:
storing, by a map storage, a target relative humidity map in which a target relative humidity corresponding to a vapor pressure of the fuel cell stack and a coolant temperature of the fuel cell stack is recorded;
calculating, by a fuel cell controller, a relative humidity of the fuel cell stack using a vapor pressure of air discharged from the fuel cell stack and a saturated vapor pressure at a coolant temperature;
determining, by the fuel cell controller, a state of the fuel cell stack using the calculated relative humidity of the fuel cell stack on the basis of the target relative humidity map; and
setting, by the fuel cell controller, an amount of airflow or a coolant temperature of the fuel cell stack according to the state of the fuel cell stack.

16. The method according to claim 15, wherein the storing of the target relative humidity map further comprises storing a maximum relative humidity map and a minimum relative humidity map generated based on the target relative humidity map.

17. The method according to claim 16, wherein the setting of the amount of airflow comprises:
reducing the amount of airflow to increase the relative humidity of the fuel cell stack when the relative humidity of the fuel cell stack is between the target relative humidity map and the minimum relative humidity map; and
increasing the amount of airflow to reduce the relative humidity of the fuel cell stack when the relative humidity of the fuel cell stack is between the target relative humidity map and the maximum relative humidity map.

18. The method according to claim 16, wherein the setting of the coolant temperature comprises:
reducing the coolant temperature to increase the relative humidity of the fuel cell stack when the relative humidity of the fuel cell stack corresponds to a minimum relative humidity; and
increasing the coolant temperature to reduce the relative humidity of the fuel cell stack when the relative humidity of the fuel cell stack corresponds to a maximum relative humidity.

19. The method according to claim 18, wherein the setting of the coolant temperature comprises:
setting the coolant temperature to be lower than the coolant temperature of the target relative humidity map by a threshold value when the relative humidity of the fuel cell stack corresponds to the minimum relative humidity; and
setting the coolant temperature to be higher than the coolant temperature of the target relative humidity map by a threshold value when the relative humidity of the fuel cell stack corresponds to the maximum relative humidity.
